(19) United States
(12) Patent Application Publication
(10) Pub. No.: US 2006/0134370 A1
(43) Pub. Date: Jun. 22, 2006

(54) Article with fabric-backed decorative element and method of fabricating the same

(76) Inventor: Clifford A. Lowe, Rocky Mount, NC (US)

Correspondence Address: FRED ZOLLINGER III, P.O. BOX 2368, NORTH CANTON, OH, 44720, US

(21) Appl. No.: 10/545,249

(22) PCT Filed: Feb. 12, 2004
(86) PCT No.: PCT/US04/04250

§ 371 Date: Aug. 10, 2005

Related U.S. Application Data
(60) Provisional application No. 60/447,049, filed on Feb. 12, 2003.

(51) Int. Cl. B29C 45/14

(52) U.S. Cl. 428/67; 264/257; 264/255; 156/245

(57) ABSTRACT

An article has a fabric-backed decorative element. The invention provides a method including the steps of: (a) forming a decorative element by attaching a material to at least one section of fabric; (b) placing the decorative element in a mold with the decorative element facing the inner surface of the mold; (c) adding body material that forms the body of the article to the mold over the decorative element; (d) heating the mold to form the body of the article from the body material and to permanently connect the decorative element to the body; and (e) cooling the article. The invention also provides a method including the steps of (a) forming a decorative element by attaching a material to at least one section of fabric; (b) providing an article having a body; and (c) attaching the decorative element to the body.

### BACKGROUND OF THE INVENTION

1. Technical Field

The present invention generally relates to articles with fabric-backed decorative elements and, more particularly, to methods for connecting the elements to the article. Specifically, the invention relates to the use of a fabric backing to support the elements on a molded article such as a parking curb, a speed bump, a dock bumper, a rubber mat, a wheel block, or a mud flap.

2. Background Information

Various products are fabricated from rubber or a rubber-based material. These products include parking curbs, speed bumps, dock bumpers, rubber mats, wheel blocks, and mud flaps. Those who purchase and use these products desire to place decorative elements on the products. Decorative elements may be in the form of a company's name or logo or an image. In the context of this application, a decorative element may be a reflective element that helps the product to be seen in low light situations. In this configuration, the decoration element may simply be a reflective stripe or a plurality of reflective stripes. In the past, the article was molded from a rubber material and the decorative elements were painted onto the article after the molded body had cooled. One drawback with this method is that the mold release agent must be removed before the paint is applied. Then, several coats of paint are required to completely cover a dark object such as those fabricated from black rubber. One type of reflective paint used in these applications is a polyurethane-type paint that includes glass beads that help catch and reflect light. Ideally, the beads should be 60 percent embedded within the paint. Several coats of paint may be needed to properly embed the reflective beads in the paint. Each coat of paint must dry before an additional coat is applied requiring time and floor space. Fabrication processes that require multiple layers of paint are undesirable because of the drying time and space requirements. A drawback with these devices is that the reflective paint is worn away, especially when the article is driven over by vehicles—such as when the article is a speed bump. In addition to the drawback of the paint wearing off of the body of the article, the glass beads can be pushed into the paint or pushed out of the paint rendering them useless.

Another known method for manufacturing molded articles with reflective markings is to apply a polymeric tape having reflective glass beads to the molded article. When the tape is post-applied, the mold release agent must be removed from the molded article before the tape can be applied. In addition, an adhesive must be used to hold the tape and the adhesive must be allowed to cure. Some manufacturers place the beaded polymeric tape in the mold before the rubber material is inserted into the mold. In this method, the tape is molded directly to the article but the glass beads are pushed through the tape into the rubber body of the article destroying their reflective properties. In view of these problems, the art desires a structure for a reflective article that helps prevent the glass beads from being pushed into the article while also increasing the life of the article.

### BRIEF SUMMARY OF THE INVENTION

The invention provides a method for forming an article having a body with a decorative element attached to the body. The method includes the steps of: (a) forming a decorative element by attaching a material to at least one section of fabric; (b) placing the decorative element in a mold with the decorative element facing the inner surface of the mold; (c) adding body material that forms the body of the article to the mold over the decorative element; (d) heating the mold to form the body of the article from the body material and to permanently connect the decorative element to the body; and (e) cooling the article.

The invention also provides a method for making an article having a body with a decorative element attached to the body. The method includes the steps of (a) forming a decorative element by attaching a material to at least one section of fabric; (b) providing an article having a body; and (c) attaching the decorative element to the body.

The invention also provides an article having a body and a decorative element wherein the decorative element includes a material connected to a section of fabric that is attached to the body of the article. In one embodiment, the material is a reflective paint.

### BRIEF DESCRIPTION OF THE SEVERAL VIEWS OF THE DRAWINGS

FIG. 1 is a side elevation view of a parking curb made in accordance with the concepts of the present invention.

FIG. 2 is a perspective view of the parking curb of FIG. 1 showing three decorative elements attached to the body of the parking curb.

FIG. 3 is an exaggerated section view taken along line 3-3 of FIG. 2.

FIG. 4 is an exploded view showing the reflective paint material being added to the back-coated fabric.

FIG. 5 is an exploded view showing the adhesive being added to the painted, back-coated fabric.

FIG. 6 is an exploded view of a schematic mold with the reflective fabric material disposed above the mold and the rubber-based product positioned to form the body of the product.

FIG. 7 is a view similar to FIG. 6 showing the rubber-based material being inserted into the mold with the decorative elements positioned in the mold.

FIG. 8 is a view similar to FIG. 6 showing the product being cured in the mold.

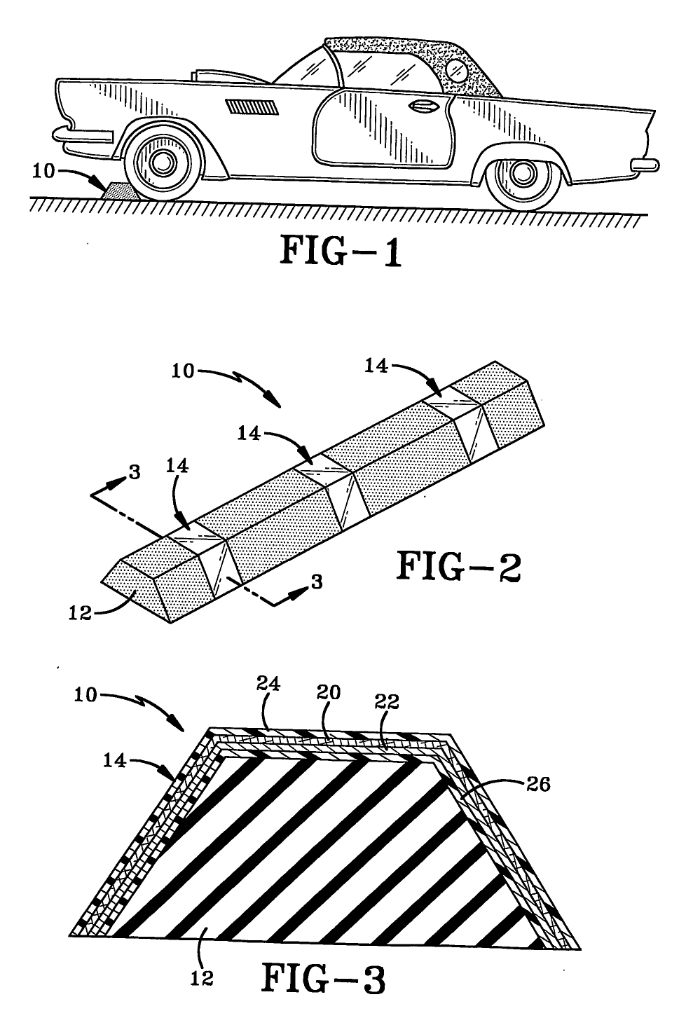

Similar numbers refer to similar parts throughout the specification.

### DETAILED DESCRIPTION OF THE INVENTION

An exemplary product having the decorative element made in accordance with the method of the present invention is the parking curb indicated generally by the numeral 10 in the drawings. In addition to the exemplary parking curb 10, the structure and method of the present invention may be used with a wide variety of molded products that use decorative elements. These products include, but are not limited to, speed bumps, dock bumpers, rubber mats, wheel blocks, and mud flaps. Each of these products, as shown with respect to the exemplary parking curb 10, includes a body 12 and a decorative element 14 attached to body 12.

Each decorative element 14 includes a fabric layer 20 that supports the material that forms the image. The material may be a paint, an ink, a dye, or other substance or substances used to form the image to be viewed. In the exemplary embodiment shown in the drawings, fabric 20 is coated with reflective paint. Fabric 20 is optionally back coated by applying layer 22 to fabric 20. Back-coating layer 22 helps fabric 20 retain the reflective paint by helping prevent the reflective paint 24 from bleeding through fabric 20. Reflective paint 24 is any of the variety of reflective paints known in the art and may include reflective beads. These reflective paints are non-discoloring, UV stable polyurethane or epoxy based paints. For instance, the paint may be a polyurethane paint prepared from aliphatic or cycloaliphatic di-, or polyisocyanates that are cured with short chain aliphatic or cycloaliphatic diols and/or polyols composed from polyester or polyacrylic materials and other materials known in the art. An adhesive or primer 26 is optionally used to help secure the back-coated fabric 20 to body 12 during the molding process. The adhesive may be a heat set adhesive. Examples of adhesives that may be used include product 1751A from Syntac Coated Products and a nitrile/phenolic resin thermosetting type identified as 03-1121A.

Fabrics 20 include those textile structures comprising mechanically interlocked fibers or filaments. These fibers or filaments can be woven or non-woven. In other words, woven fabrics include closely oriented warp and filler strands. In a preferred woven fabric, the warp and filler strands are at right angles to each other. The non-woven fabric includes those fibers or filaments that are randomly integrated. Many procedures are known in the art for mechanically interlocking non-woven fibers or filaments. One method commonly employed in the art is needle punching.

Any fiber or filament employed in the textile arts can be employed to make the fabrics employed in the present invention. These fibers or filaments include both natural, synthetic, and semi-synthetic materials. Natural fibers include those obtained from animals including wool and silk, those obtained from vegetables including cotton, and those obtained from mineral sources such as asbestos. Synthetic fibers include high polymers such as polyamides (e.g., Nylon 6, and Nylon 6,6), polyesters, polyaramides (e.g., Kevlarä), acrylics, and polyolefins. Semi-synthetic fibers include rayon and inorganic substances extruded in fibrous form, such as glass, boron, boron carbide, boron nitride, carbon, graphite, aluminum silicate, fused silica, and some metals. Useful fibers and filaments are generally characterized by a denier of about 40 to about 2,000, preferably from about 60 to about 400, and more preferably from about 100 to about 250. The fiber or filament dimensions can also be provided by (dpf) values, which are commonly known in the art. Accordingly, useful fibers and filaments can be characterized by a dpf of 0.8 to about 2.4, preferably from about 1.0 to about 2.2, and more preferably form about 1.2 to about 2. The fibers and filaments prepared within the fabrics employed in the present invention can be treated. The treating of fibers is well known in the textile arts. For example, it is common to treat nylon filaments with resorcinol-formaldehyde liquid (i.e., RFL coatings) or with various softening and sizing agents including butadiene a crylonitrile polymer latexes. The matrix or support layer (i.e., the fabric) preferably has a thickness from about 0.005 cm to about 0.05 cm, more preferably from about 0.01 cm to about 0.03 cm, and even more preferably from about 0.015 cm to about 0.025 cm. Numerous useful fabrics are available from a number of suppliers within the textile industry. Useful fabrics can be purchased from Johnston Industries, Inc. (Valley, Ala.).

The fabric may be colored to match the primary color of the decorative element 14. For example, fabric 20 may be colored to match the color of the reflective paint. A fabric having the same color as the image will hide damage to the decorative element.

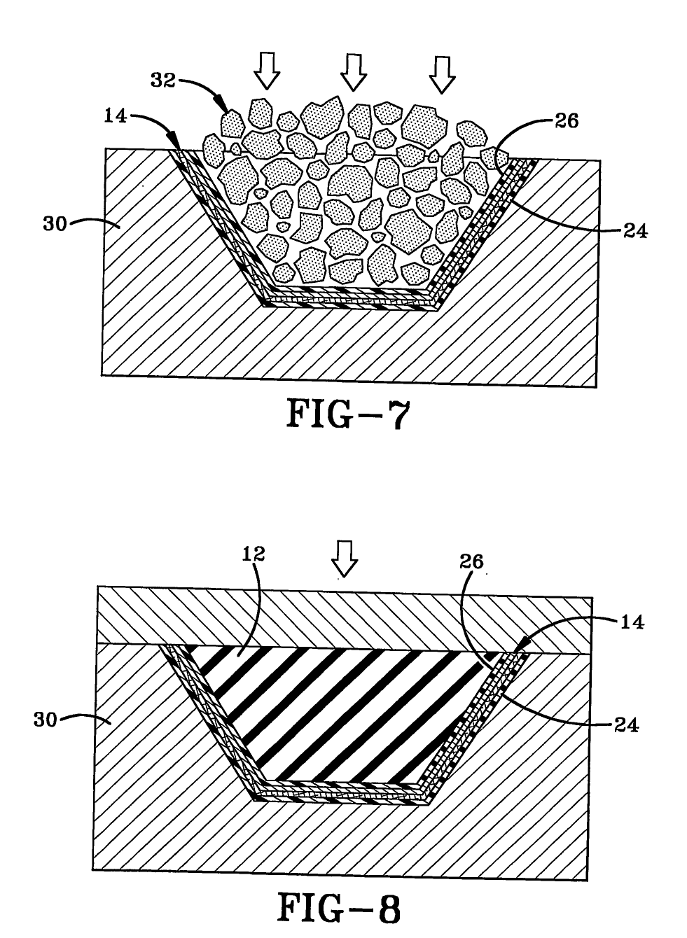

The molding process is depicted in FIGS. 4-8. In FIG. 4, material in the form of reflective paint is applied to the back-coated fabric 20 to form decorative element 14. The reflective beads are properly embedded into the paint during a controlled manufacturing process wherein the proper amount of bead embedding within the paint is achieved. In FIG. 5, an optional primer 26 is added to the back-coated side of fabric 20 after paint 24 is dried. Exemplary primers are Product Code R751 (Bayer's Desmodur RFE) available from McCullough & Associates in Charlotte, N.C. and Product Code MD-400 (Ryvec's D400) available from Ryvec, Inc. FIG. 6 shows an example of a mold 30 and the rubber-based body material 32 used to form body 12. Body material 32 may be created from recycled vehicle tires. Body material 32 may be a combination of ground rubber particles and a polyurethane or other material that functions as a binding agent. The binding agent may be an adhesive or ground uncured rubber that will cure to hold the ground cured rubber particles in place. Element 14 is positioned against the inner surface of the mold 30 in the desired positions such as the three positions depicted in FIG. 2. The inner surface of element 14 faces inwardly and is exposed to the mold cavity. Body material 32 is then added to the cavity of mold 30 over the top of element 14 directly against primer 26 as shown in FIG. 7 or directly against the inwardly-facing surface of element 14. Appropriate heat and/or pressure are then applied to mold 30 so that body material 32 forms body 12 and securely attaches body 12 to element 14.

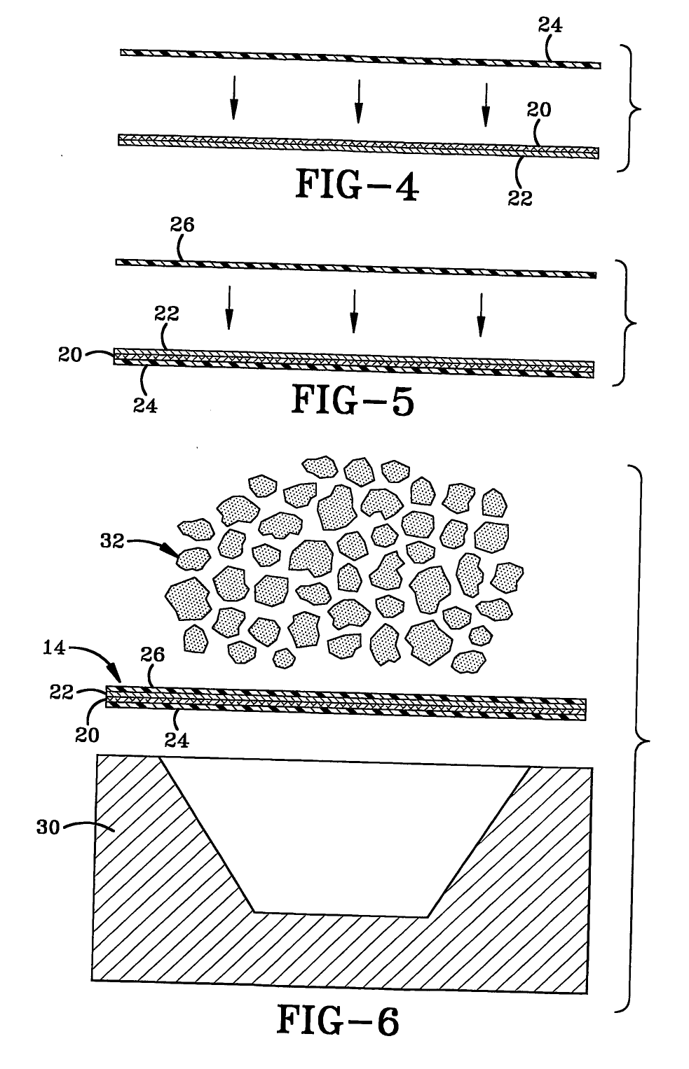

Article 10 shown in FIG. 3 has increased reflective light because element 14 wears better than the prior art structures having paint applied directly to a molded product. Fabric 20 also helps prevent any reflective beads disposed in paint 24 from becoming pushed out of paint 24 by cushioning the beads. Fabric 20 thus maintains the proper position of the beads with respect to the paint so that the beads will properly reflect. Another advantage with the invention is that the article may be placed into service as soon as the rubber cures because the paint is already dried. A further advantage is that multiple layers of paint do not have to be applied to obtain a solid, thick reflective layer of paint. This method thus eliminates the repetitive painting and drying steps.

Another method for fabricating article 10 is to fabricate body 12 with any traditional manner and then attach decorative element 14 to the body with an appropriate adhesive. When body 12 is a cured rubber body, the cured rubber surface must be primed and an adhesive is used to connect decorative element 14 to body 12. Appropriate adhesives include 2,4,6-Trichloro-1,3,5-triazinetrione (TCTT), MD-400, and/or Desmodur RFE, as well as equivalent materials. Appropriate primers are described above. This embodiment has the advantage that the fabric-based element 14 is easy to size and cut. Decorative element 14 may be recessed into a depression formed in body to further increase the durability of element 14. The depression may be deeper than the thickness of element 14 or may allow a portion of element 14 to extend above the surface of the molded body.

Another method for connecting decorative elements 14 with formed bodies is advantageous for use with high temperature mold methods where the high temperature of the mold process would destroy or damage any fabric placed in the mold. This method first forms the body with the high temperature molding process. The formed body is removed from the mold and decorative element 14 is placed into the mold cavity with a binding agent or an adhesive on the decorative element. The body is then placed back into the mold cavity over lo the decorative element. The combination is heated to connect the fabric to the molded part. The alternative method is useful for attaching reflective decorative elements to parts that are already cured such as previously-manufactured mud flaps. The heat set adhesive system described above allows the rubber part to be cured and then joined to the fabric.

Another urethane that may be used as an adhesive is a urethane dispersion known as Cydrothane HP-5035 with an optional crosslinker. This is supplied by Cytech Industries.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A method for forming an article having a body that defines an outer surface with a decorative element attached to the body; the method comprising the steps of:
(a) forming a decorative element by attaching a material to at least one section of fabric;
(b) placing the decorative element in a mold with the decorative element facing the inner surface of the mold;
(c) adding body material that forms the body of the article to the mold over the decorative element;
(d) heating the mold to form the body of the article from the body material and to permanently connect the decorative element to the body; and
(e) cooling the article.

2. The method of claim 1, further comprising the step of back-coating the section of fabric before the material is applied to the section of fabric to form the decorative element.

3. The method of claim 1, further comprising the steps of applying an adhesive to the inwardly-facing surface of the decorative element before step (c) and placing the body material in the mold against the adhesive during step (c).

4. The method of claim 3, further comprising the step of applying a heat set adhesive to the decorative element.

5. The method of claim 1, further comprising the step of coloring the fabric to match the color of the element.

6. The method of claim 1, wherein step (a) includes the step of providing the material in the form of a reflective paint.

7. The method of claim 6, wherein step (a) includes the step of providing a reflective paint having a plurality of reflective beads.

8. The method of claim 7, wherein step (a) includes the step of applying the reflective paint in a manner that properly embeds the reflective beads in the paint that is applied to the fabric.

9. The method of claim 1, wherein step (c) includes the step of providing the body material in the form of recycled rubber pieces.

10. The method of claim 1, wherein step (c) includes the step of providing the body material in the form of shredded tires.

11. The method of claim 1, wherein step (c) includes the step of providing the body material in the form of recycled rubber pieces in combination with a binding agent.

12. The method of claim 11, wherein step (c) includes the step of providing the body material in the form of recycled rubber pieces in combination with a polyurethane.

13. The method of claim 11, wherein step (c) includes the step of providing the body material in the form of recycled rubber pieces in combination with uncured rubber.

14. A method for making an article having a body that defines an outer surface with a decorative element attached to the body; the method comprising the steps of:
(a) forming a decorative element by attaching a material to at least one section of fabric;
(b) providing an article having a body; and
(c) attaching the decorative element to the body.

15. The method of claim 14, further comprising the step of back-coating the section of fabric before the material is applied to the section of fabric to form the decorative element.

16. The method of claim 14, further comprising the steps of applying an adhesive to the decorative element before step (b) and attaching the decorative element to the body with the adhesive in step (c).

17. The method of claim 16, further comprising the step of placing the decorative element and body in a mold and heating the mold to connect the decorative element to the body.

18. The method of claim 14, further comprising the step of forming a depression in the body of the article and placing the decorative element in the depression of the body.

19. The method of claim 14, wherein step (a) includes the step of providing the material in the form of a reflective paint.

20. The method of claim 19, wherein step (a) includes the step of providing a reflective paint having a plurality of reflective beads.

21. The method of claim 20, wherein step (a) includes the step of applying the reflective paint in a manner that properly embeds the reflective beads in the paint that is applied to the fabric.

22. An article having a body and a decorative element; the improvement characterized in that: the decorative element includes a material connected to a section of fabric that is attached to the body of the article.

23. The article of claim 22, wherein the material connected to the section fabric is a reflective paint.

24. The article of claim 23, wherein the reflective paint includes a plurality of reflective beads.

25. The article of claim 24, wherein the section of fabric is back coated.

26. The article of claim 24, wherein the body of the article is molded from recycled rubber.

27. The article of claim 26, wherein the fabric has a dpf of 0.8 to about 2.4

28. The article of claim 27, wherein the fabric has a thickness from about 0.005 cm to about 0.05 cm.
